(19) United States
(12) Patent Application Publication
(10) Pub. No.: US 2003/0058511 A1
(43) Pub. Date: Mar. 27, 2003

(54) Method and system for transmitting a signal via a non linear transmission unit

(76) Inventor: Leonid Bogod, Helsinki (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/130,233

(22) PCT Filed: Sep. 21, 2001
(86) PCT No.: PCT/EP01/10921

(51) Int. Cl. G02B 6/00; H04B 10/04; H04B 10/12

(52) U.S. Cl. 359/188; 385/140

(57) ABSTRACT

The invention relates to a system and method for transmitting a signal via a non-linear transmission unit, wherein the system aims to reduce distortion in the signal after transmission caused by intermodulation products. For achieving a decrease of intermodulation products in the output signal the system comprises a power splitter 110 for dividing the signal into a main signal and an auxiliary signal. The system further includes a power variation detector 120 for detecting power variations in said auxiliary signal and for generating a control signal representing said power variations. The system further includes a variable attenuator 130 for attenuating the power of said main signal in response to said control signal such that the said power of the main signal being input to said non-linear transmission line 200a is kept constant if the power of the input signal exceeds a predetermined reference power value P_{ref}. After transmission the signal is recovered by amplifying the main signal by a first variable gain amplifier 310 in response to said control signal.

### FIELD OF THE INVENTION

The invention relates to a method and system comprising a preparation unit and a restoration unit for transmitting a signal via a non-linear transmission unit, in particular a fiber-optical link.

### BACKGROUND OF THE INVENTION

Such systems are for example known from Satellite or telecommunications application. These applications usually require a high dynamic range, preferably in combination with a band width of several MHz, for the transmission units because the power of typical input signals can vary in a dynamic range of e.g. 100 dB.

A traditional approach for fulfilling these requirements is to use fiber-optical links as shown in FIG. 8. Such fiber optical-links have the advantages of low loss, high bandwidth and low-weight. According to FIG. 8 they comprise a laser diode 850 for receiving a signal and transforming said signal into a modulated light signal. The fiber-optical link further comprises a fiber 860 for transmitting said light signal to a photo diode 870 which restores the signal input to said laser diode 850 from said modulated light signal after transmission. The high dynamic range required for such transmission units requires a linear transmission characteristic thereof. However, fiber-optic links are non-linear transmission units, in particular due to the non-linear behaviour of the laser diode. The output signals of said non-linear transmission units comprise undesired distortions caused by intermodulation in said non-linear device.

Intermodulation means the production of frequency components in the output signal of a non-linear device; said frequency components correspond to the sum and difference frequencies of signals from a wanted channel (desired) and from neighbor channels (undesired) which are coming to the system input.

Further, intermodulation product means a specific one of said frequency components.

More specifically, a second order intermodulation product is characterised by a frequency of f1-f2 or of f2-f1 and a slope of 2 in an output power to input power diagram of said non-linear device. Further, a third order intermodulation product is characterised by a frequency of (2f1-f2) or (2f2-f1) wherein its curve in a output to input power diagram has a slope of 3.

An approach to decrease the undesired influence of said intermodulation products and to achieve a high dynamic range in a fiber optical link may be the usage of very high quality laser-diodes and/or external modulators. However, both ways are very expensive.

In U.S. Pat. Nos. 5,321,849 and 5,457,811 and in the article from IEEE publication “A dynamic range enhancement technique for fiber optic microcell radio systems”, Cheng, F., Lemson, P., Reed, J. H., Jacobs, I. Vehicular Technology Conference, 1995 IEEE 45^{th}, Volume 2, 1995 pages 774-778, systems for increasing the dynamic range for a transmission link are disclosed, respectively. It is a common feature of all these prior art system that the control signal is generated from the transmitted signal and that the control signal adjusts the transmitted signal before it entering the non-linear transmission unit.

### OBJECT OF THE INVENTION

Starting form that prior art it is the object of the invention to improve the dynamic range of a system and method for transmitting a signal via a non-linear transmission unit.

### SUMMARY OF THE INVENTION

Said object is solved by the subject matters of independent claims 1 and 9, respectively.

According to claim 1 said object is solved by a power splitter for dividing the signal into a main signal and an auxiliary signal; a power variation detector for detecting power variations in said auxiliary signal and for generating a control signal representing said power variations; a variable attenuator for attenuating the power of said main signal in response to said control signal such that the power of said main signal being input to said non-linear transmission unit (200a) is kept constant; and by an amplifier for amplifying the main signal after transmission via said non-linear transmission unit in response to said also transmitted control signal in order to restore the signal again.

Because the power of the main signal output by the variable attenuator and input to said non-linear transmission unit is constant the ratio of the fundamental signal and the intermodulation product output by said transmission unit are constant too. Thus, the proposed system sufficiently enables transmission of signals having a very high dynamic range via non-linear transmission units by decreasing second and third order intermodulation products.

Thus the linearity of the system and in particular of the transmission unit is improved and distortions of the signal output by the system are reduced. Instead of expensive transmission units having an improved linearity low cost transmission units can be used.

According to a first embodiment said system comprises a comparator for comparing the power of said auxiliary signal with a predetermined reference power value and for generating the control signal representing the result of said comparison. Advantageously said comparator enables the detection of said power variations.

Advantageously, the system comprises a second amplifier for amplifying the control signal after being transmitted via said main transmission device or via said other transmission unit but before being input to the first amplifier. Said second amplifier compensates losses in said other transmission unit in the way that the control signal applied to the controlled first amplifier is the same as input to said variable attenuator. In that way exact reversion of the attenuation by said controlled first amplifier is ensured.

According to another embodiment the system advantageously comprises another transmission unit for transmitting the control signal to the first amplifier. No high linearity characteristics are required for said other transmission unit with the result that low cost components, in particular low cost digital laser diodes or cheap light emitting diodes LED may be used. The system is based on the idea that variations in the input/output power occur over a slower time scale for most cellular protocols as for a wideband code division multiple access (W-CDMA) or for a global system for mobile communications (GSM) transmissions. Therefore, no phase adjustment device are required.

Alternatively, the control signal is not transmitted via said other transmission line but via the same transmission line as used for the main signal by using wavelenth division multiplex (WDM) technique. For carrying out that technique the non-linear transmission unit of the system comprises: a laser diode for converting the main signal into a first optical signal; a light emitting diode for converting the control signal into a second optical signal; a multiplexer for generating a multiplex signal by multiplexing the first and the second optical signal; an optical fibre for transmitting said multiplex signal from said multiplexer to a demultiplexer, wherein the demultiplexer serves for restoring said first optical signal and said second optical signal from said transmitted multiplex signal after transmission via said optical fibre and for outputting these optical signals to two separate photo diodes for restoring the main and the control signal, respectively.

The object is further solved by the method according to claim 8. The advantages of said method correspond to the advantages of the system as mentioned above.

Advantageously, the control signal is embodied such that the power of the main signal is kept constant only if the power of the input signal exceeds said predetermined reference power value.

The object is further solved by a preparation unit to be used in a system as mentioned above and comprising the power splitter, the power variation detector and the variable attenuator. The preparation unit advantageously ensures the generation of the main signal from the input signal such that the power of the power of the main signal is kept constant after some setting power if the power of the input signal exceeds a predetermined reference power value P_{ref}. The main signal is transmitted via said non-linear transmission line.

The object is further solved by a restoration unit to be used in a system as mentioned above and comprising the amplifier. Said restoration unit advantageously enables a proper recovering of the signal from the transmitted main signal.

### BRIEF DESCRIPTION OF THE DRAWINGS

The following figures accompany the description, wherein

FIG. 1 shows a block diagram of the system according to a first embodiment of the invention;

FIG. 2 shows a second embodiment of a transmission unit of the system shown in FIG. 1;

FIG. 3 is a diagram illustrating the power ratio of a fundamental signal component and a third order intermodulation product in the output signal of a non-linear device;

FIG. 4 shows a diagram illustrating the decrease of the power of the third order intermodulation product in a fiber-optic link according to the present invention;

FIG. 5 is a power output to power input diagram illustrating the power of a third order intermodulation product in the output signal of a typically non-linear device in response to the input power;

FIG. 6 is a power output to power input diagram illustrating the decrease of the third order intermodulation product in the output signal of the system according to the present invention for a first set of simulation parameters;

FIG. 7 is an output power to input power diagram illustrating the decrease of the third order intermodulation product achieved for the system according to the present invention for a second set of simulation parameters;

FIG. 8 shows a block diagram of a fiber-optical link as an embodiment for a non-linear transmission device as known in the art; and

FIG. 9 shows a modification of the block diagram according to FIG. 1.

### DESCRIPTION OF THE PREFERRED EMBODIMENTS OF THE INVENTION

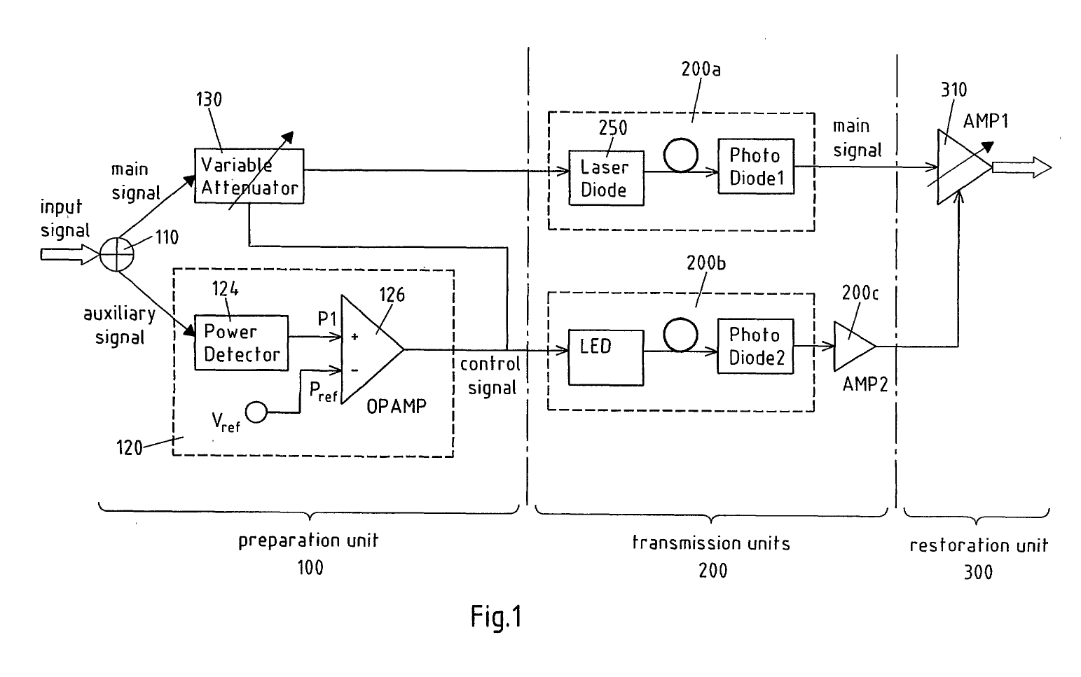

In the following the invention will be described in more detail by referring to FIGS. 1 to 7.

FIG. 1 shows a first embodiment of the system according to the invention. The system comprises a preparation unit 100, transmission units 200 and a restoration unit 300.

The preparation unit 100 comprises a power splitter 110 for dividing a signal, hereinafter referred to as input signal, into a main signal and an auxiliary signal, wherein the ratio of the power of the main signal and the power of the auxiliary signal is e.g. 1:10. The auxiliary signal is communicated to a power variation detector 120 for detecting power variations in said auxiliary signal and for generating a control signal representing said power variations. For achieving this the power variation detector 120 comprises a power detector 124 filtering a power signal out of said auxiliary signal and outputting said power signal to a comparator 126 also being comprised within said power variation detector 120. Said comparator 126 compares the power of said power signal with a predetermined reference power value P_{ref} represented by a reference voltage V_{ref}. In that way the comparator 126 detects the power variations of the auxiliary signal and generates a control signal representing said power variations.

Said control signal is communicated to a variable attenuator 130 for attenuating the power of said main signal in response to said control signal.

By feeding the control signal to the variable attenuator 130 the preparation unit 100 ensures that the power of the main signal is kept constant when the power P1 of the auxiliary signal exceeds said reference power value.

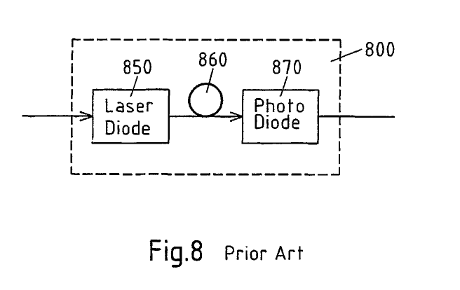

According to FIG. 1 the main signal as well as the control signal are transmitted from the preparation unit 100 to a restoration unit 300 via a first embodiment of the transmission units 200, i.e. via individual transmission units 200a and 200b, respectively. Both transmission units 200a, 200b are e.g. fiber-optical links as known in the art and as described above by referring to FIG. 8. It is assumed that in particular the transmission unit 200a for transmitting the main signal is a non-linear transmission unit in particular due to the non-linear characteristics of a laser diode 250.

The laser diode 250 may be any type of a laser diode with no specific linearity requirements for certain applications; thus, it may be a cheap laser as a Fabry-Perot-Laser which is usually used for digital applications (digital laser) or it might be a high linearity expensive laser as a DFB laser which is usually used for analog applications. However, it shall once more be emphasised that the laser diode 250 in the transmission unit 200a for transmitting the main signal is assumed to have not sufficient linearity for a certain application.

Moreover, the linearity requirements for the second transmission unit 200b for transmitting the control signal from the preparation unit 100 to the restoration unit 300 are also very low and thus, the laser diode in the fiber-optical link 200b may be replaced by a cheap Fabry-Perot laser or by just a light emitting diode LED.

After transmission via the non-linear transmission unit 200a the main signal having a constant power when the power of the input signal has exceeded P_{ref}, is received and amplified by an amplifier 310 in the restoration unit 300. Amplification of said amplifier 310 and thus, the amplification of the received main signal is controlled by the control signal which has been transmitted to the restoration unit via said second transmission unit 200b.

Preferably, the transmission unit 200b or the restoration unit 300 comprises a second amplifier 200c for amplifying said control signal after being transmitted and before being input to said controlled first amplifier 310. The gain of said second amplifier 200c is preferably adapted to compensate losses in said second transmission unit 200b. In that case the control signal applied to the variable attenuator 130 and to the controlled first amplifier 310 are the same. In that way the system according to the invention and more specifically the controlled first amplifier 310 is adapted to recover the main signal at the output of the first amplifier 310 to its initial value, that means to the input signal. Expressed in other words the controlled first amplifier 310 is adapted to compensate for the attenuation provided by said variable attenuator 130.

In general the gain G₂ of the second amplifier 200c can be calculated as:

$${G}_{2} = \frac{a 1 \cdot L 2}{a 2} \qquad ( 1 )$$

wherein:

L2: represents the loss in the second optical link;

a1: is a proportional coefficient for the variable attenuator; and

a2: is a proprotional coefficient for the variable amplifier.

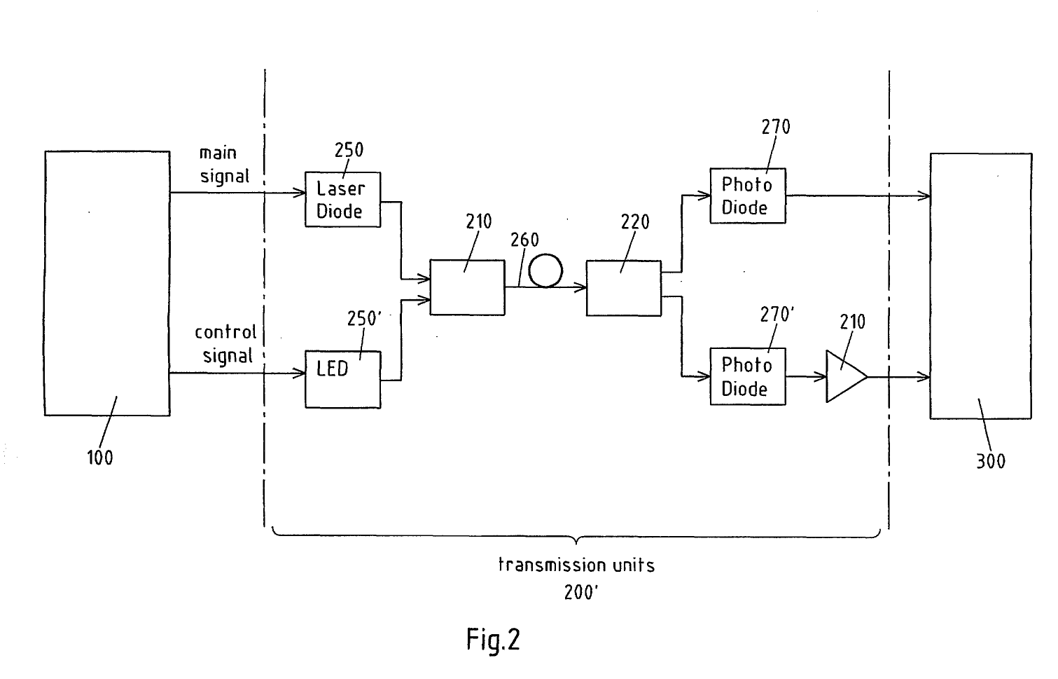

FIG. 2 shows a second embodiment of the transmission unit of the system according to the present invention shown in FIG. 1. According to FIG. 2 both signals the main signal and the control signal, respectively, are transmitted via the same optical fibre 260, using WDM technique.

In order to achieve this in its second embodiment 200′ the transmission unit is embodied as fibre-optic link comprising a laser diode 250 for converting the main signal into a first optical signal and comprising a light emitting diode 250′ for converting the control signal into a second optical signal. Said first and second optical signals are both communicated to a multiplexer 210 for generating a multiplex signal by multiplexing said two optical signals. The multiplex signal is an optical signal, too, being output from said multiplexer and transmitted via an optical fibre 260 to a demultiplexer 220. The demultiplexer 220 serves for separating said first and said second optical signal from said transmitted multiplex signal and for outputting the separated optical signals to two separate photo diodes 270, 270′ converting the optical signals into the main signal and the control signal, respectively.

Preferably, the control signal is amplified by the second amplifier 200c before being communicated to the first amplifier 310. For operation of said second amplifier 200c see the description of FIG. 1.

As mentioned above, in the system according to the invention the main signal being transmitted via said non-linear transmission unit according to the first or the second embodiment, has a constant power when the power of the input signal exceeds the predetermined reference power value P_{ref}.

The constancy of the power of the main signal during transmission via one of said non-linear transmission units 200a or 200′ causes a decrease of the third order intermodulation product IM3 in the main signal when being output from said linear transmission unit 200a or 200′. Consequently, the IM3 product is also decreased in the input signal after recoverage from said main signal, i.e. after being output by said controlled first amplifier 310 of the restoration unit 300. Due to said decrease of the IM3 product distortions of the main signal caused by the first or the second embodiment of the non-linear transmission unit 200a or 200′ are reduced and in that way linearisation or—expressed in other words—a higher dynamic range of the system is achieved. Thus, the system according to the invention can also be referred to as linearisation circuit.

Said gist of the present invention will now be substantiated in detail:

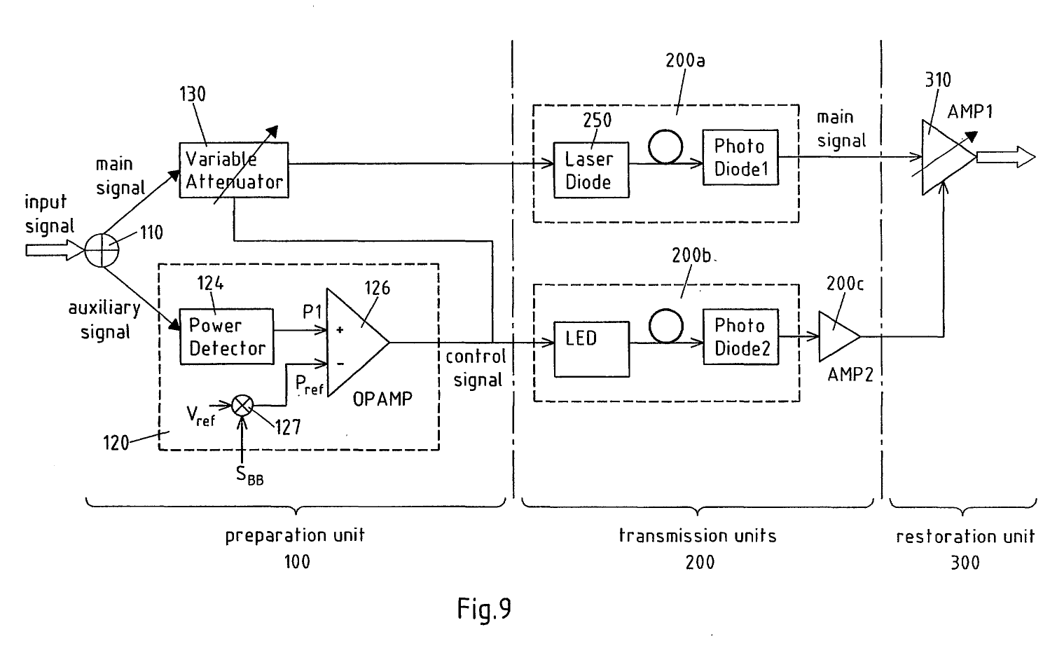

As mentioned above by referring to FIGS. 8 and 9 intermodulation products may occur in any non-linear device. For the system according to FIG. 1 or FIG. 2 the variable attenuator shall be considered as passive element which does not generate any intermodulation products. However, for the further substantiation the transmission unit 200a and the controlled first amplifier 310 shall both be considered as being non-linear devices generating intermodulation products in their output signals, respectively.

Consequently, when considering the whole system according to FIGS. 1 or 2 it is assumed that the main signal output by the controlled first amplifier comprises an intermodulation product component which can be considered as a superposition of the intermodulation product caused by the first transmission unit 200a and by the controlled first amplifier 310 itself. However, according to the present invention the intermodulation product generated by said non-linear transmission unit 200a is reduced and thus also the intermodulation product in the output signal of the controlled first amplifier is reduced.

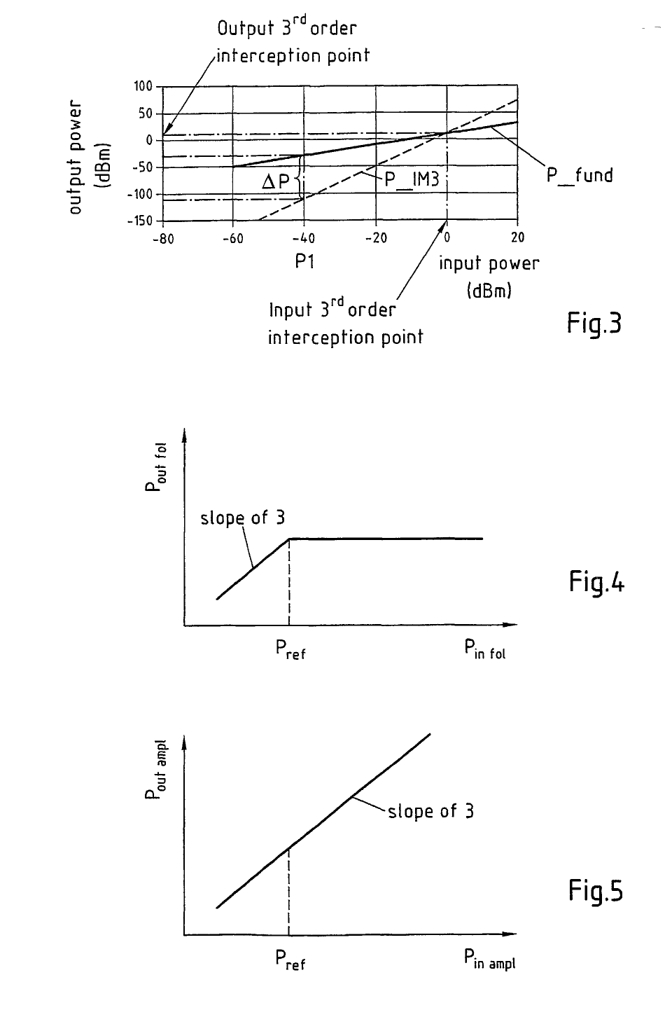

In the following that idea will be explained by referring to FIGS. 3 to 7.

FIG. 3 illustrates the ratio of the power of the fundamental signal component to the power of the third intermodulation product in an output signal of a typical non-linear device for a particular input power P1.

E.g. the output signal of such a non-linear device comprises a third order intermodulation product IM3 besides a fundamental signal component. Assuming that the signal input to said device has an input power of P1=−40 dBm the fundamental signal component in the output signal has a power P_fund of −25 dBm and the IM3 in the output signal has a power P-IM3 of about −110 dBm.

However, as can be seen from FIG. 3 the curves for the fundamental signal component P_fund and the third order intermodulation product P_IM3 in the output signal of said system have different slopes in the output power to input power diagram; more specifically, the fundamental signal component has a slope of 1 whereas the third order intermodulation product has a slope of 3 in said diagram.

Consequently, for each non-linear device an individual IM3 interception point can be defined by the intersection of the curve of the fundamental signal component P_fund and the curve of the third order intermodulation product P_IM3. Each intersection point is further defined by its co-ordinates in the output power to input power diagram according to FIG. 3, i.e. its output—and input third order intersection point.

Referring to FIGS. 1 and 2 the transmission characteristics of the non-linear transmission unit 200a as well as of the non-linear controlled first amplifier 310 can respectively be described by an individual diagram according to FIG. 3.

In the following only the third order intermodulation products IM3 but not the fundamental signal components of the non-linear transmission unit 200a and of the first controlled amplifier 310 shall be discussed, because the fundamental signal is restored by the variable gain amplifier AMP1 310 according to the control signal.

The (output) power of the third order intermodulation product P_IM3 of the non-linear transmission unit 200a, more specifically of the fiber-optical link fol can be calculated as:

P_{—}IM3_{fol}=3×Pₒᵤₜ−2×OIP3_{fol} (2)

wherein

Pₒᵤₜ: represents the power of the output signal of said non-linear transmission unit 200a; and

OIP3_{fol}: represents the output power component of the third order inception point of said non-linear transmission unit 200a.

Equation (2) provides an easy calculation for the power of the third order intermodulation product because OIP3_{fol}, does usually not depend on gain.

The power P_IM3_{fol} is schematically, i.e. without any scaling illustrated in FIG. 4.

According to FIG. 4 two regions in the curve of P_IM3_{fol} can be distinguished:

1. for input powers Pᵢₙ less than the reference power P_{ref} as explained by referring to FIG. 1, e.g. P_{ref}=−45 dBm, the curve representing the P_IM3_{fol} shows an ordinary behaviour with a slope of 3.

2. For input powers Pᵢₙ exceeding P_{ref}=−45 dBm the P_IM3_{fol} curve is horizontal, that means P_IM3 is independent of Pᵢₙ.

That constancy of the power of the IM3 for Pᵢₙ>P_{ref} means a decrease of the IM3 in the output signal of said fiber-optical link. It is caused by the constancy of the power of the main signal input to the fiber-optical link according to the invention as described by referring to FIGS. 1 and 2.

Contrary to the P_IM3_{fol} as discussed above the P_IM3ₐₘₚ₁ of the controlled first amplifier 310 can be calculated as follows:

PIM3_{Ampi}=3×Pₒᵤₜ_{_{—}}_{AMP1}−2×OIP3_{AMP1} (3)

wherein

PIM3_{AMP1}: represents the power of the third intermodulation product in the output signal of the first controlled amplifier 310;

Pₒᵤₜ_{_{—}}_{AMP1}: represents the output power of the fundamental signal component in the output signal of the first amplifier 310;

OIP3_{AMP1}: represents the output power component of the third order interception point of the first amplifier 310.

From formula 3 it is apparent that the power of the IM3 in the output signal of a non-linear amplifier e.g. the first amplifier 310, is small when the parameter OIP3_{AMP1} is high.

For a correct restoration of the amplitude a variable fiber-optical link gain G_{TOTAL} should be constant. It is calculated according to:

G_{TOTAL}=−Lₐₜₜ+Gₗᵢₙₖ+G_{AMP1} (4)

wherein:

Lₐₜₜ: loss of the attenuator in dB

Gₗᵢₙₖ: First link gain in dB

G_{AMP1}: AMP1 power gain in dB.

Lₐₜₜ depends on input power Pᵢₙ due to feedback from OPAMP 126 according to FIG. 1 and can be described as:

Lₐₜₜ=L₀+(Pᵢₙ−P_{ref})+al, (5)

wherein:

L₀: initial attenuation in dB, and

al: proportional coefficient for the variable attenuator.

Gₗᵢₙₖ does not depend on Pᵢₙ until saturation, and can be considered as constant.

G_{AMP1} depends on input power Pᵢₙ:

G_{AMP1}=G₀+(Pᵢₙ−P_{ref})+a2+Gₗᵢₙₖ₂+G_{AMP2}, (6)

wherein:

G₀: initial power gain for AMP1,

a2: proportional coefficient for the variable amplifier

Gₗᵢₙₖ₂ and G_{AMP2}: gain of the second link and second amplifier, respectively

For the amplitude restoration G_{AMP1} should be equal Latt or have constant differ independent on Pᵢₙ.

FIG. 5 illustrates the behaviour of IM3 in the output signal of a non-linear amplifier, for example the first amplifier 310 itself. It is apparent that the power of the third order intermodulation product P_IM3_{AMP1} according to equation 3 has a slope of three.

As indicated above the power of the third intermodulation product in the signal output by the controlled first amplifier 310 according to FIG. 1 PIM3_{TOTAL} can be considered as a superposition of the third intermodulation products caused by each of the non-linear transmission unit 200a, i.e. the optical-fiber link, P_IM3_{fol} and the third order intermodulation product caused by the first amplifier 310 itself P_IM3_{AMPL1}. Consequently, P_IM3_{TOTAL} can be calculated as:

P_{—}IM3_{TOTAL}=P_{—}IM3_{fol}+P_{—}IM3_{AMP1}. (7)

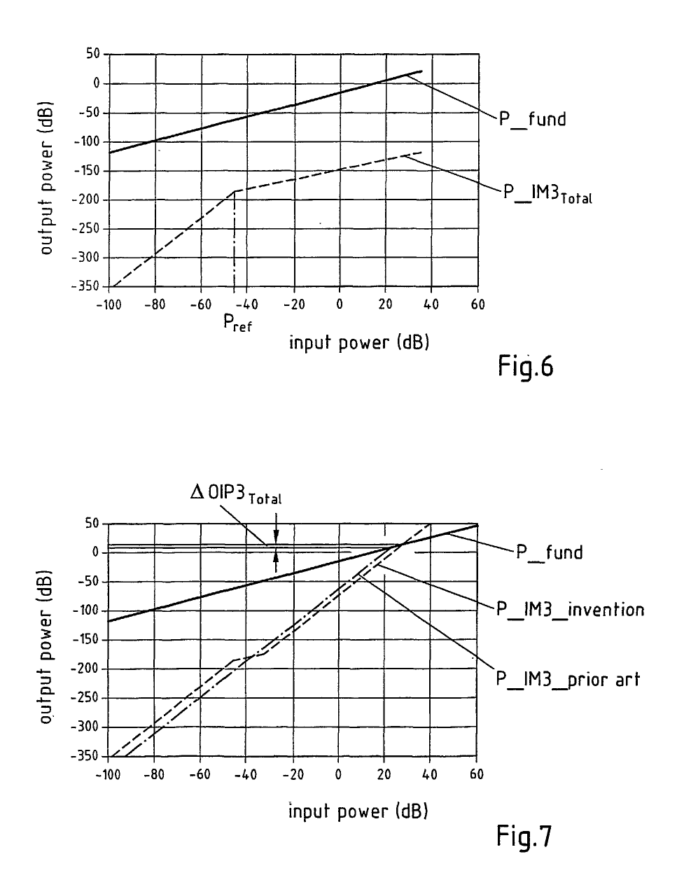

FIG. 6 illustrates the result of said superposition for the system according to FIGS. 1 or 2. More specifically, it illustrates the power of the third order intermodulation product P_IM3_{TOTAL} in the output signal of the first amplifier 310 for the system according to FIGS. 1 or 2 in response to the power of the input signal.

It is apparent that the slope of the P_IM3_{TOTAL} curve is smaller for input powers exceeding the reference power P_{ref}=−45 dBm in comparison to the slope for input powers smaller than the reference power P_{ref}. The reduced slope means a decrease of the total third order intermodulation product in the output signal of the first amplifier 310 for input powers exceeding P_{ref}=−45 dBm. Said decrease is caused by the constancy of the power of the main signal when being input to the non-linear transmission unit 200a as explained above by referring to FIG. 4.

The simulation according to FIG. 6 which further shows the fundamental signal component P_fund the output signal of a first amplifier 310 besides the P_IM3_{TOTAL} has been done with the following parameters:

Fiber-optical link gain G_{TOTAL}=−15 dB;

output power of the third order interception point of the fiber-optical link OIP3_{fol}=20 dBm; and

the output power of the third order interception point of the first amplifier OIP3_{AMP1}=100 dBm (ideal first amplifier).

As can be seen from the simulation results shown in FIG. 6 the ratio of the power of the fundamental signal to the total third order intermodulation product in the output signal of the first amplifier 310 is constant for input powers Pᵢₙ>−45 dBm (the curves for the fundamental signal component and for the IM3 product are substantially parallel).

Due to the decrease of the IM3 in the output signal of the system in response to input signals having a power greater than −45 dBm distortion in said output signal due to said IM3 is reduced (in comparison to a continuous slope of three over the whole input power range). Consequently, the system according to the present invention operates like a linearisation circuit and being capable of transmitting signals having a high dynamic range.

FIG. 7 finally shows the results of another simulation of the system according to FIGS. 1 or 2 wherein the following parameters have been set:

The fiber-optic link gain G_{TOTAL}=−15 dB

OIP3_{fol}=20 dBm, and

OIP3_{AMP1}=35 dBm.

In difference to FIG. 6 the simulation according to FIG. 7 has been done for a non-ideal amplifier 310. In that case the third order interception point of the whole system, in particular of the series connection of the non-linear transmission unit 200a and the first amplifier 310 can be seen in FIG. 7. It is apparent that for input powers exceeding the reference power P_{ref}=−45 dB the IM3 in the final output signal of the system, i.e. in the output signal of amplifier 310 is decreased for about 20 dB. As a consequence the output power of the third order interception point of the whole system OIP3_{TOTAL}, i.e. of the linearisation circuit according to FIGS. 1 or 2 is increased for about 10 dB.

Consequently, FIG. 7 illustrates that also in real systems according to the present invention a decrease of the third order intermodulation product and thus of distortions in the output signal after transmission can be achieved.

FIG. 9 shows a modification of the system according to FIG. 1. All features shown in the system of FIG. 9 are corresponding to the features of FIG. 1 with the exception that additionally, a multiplexer 127 is included. The multiplexer 127 has as its first input signal a reference voltage V_{ref} and as its second input a signal generated from the base band (BB) processor. The signal SBB is generated from a base band processor in a conventional manner.

Preferably, the reference power P_{ref} is set according to the requirement on signal to noise ratio (SNR_{spec}).

In case if said system is used for a downlink of a base station, a minimum P_{ref} could be calculated as

P_{ref}=SNR_{spec}+NFₗᵢₙₖ+N_{floor}+10*log (BW)

where are:

NFₗᵢₙₖ—noise figure of the optical link in dB

N_{floor}—transmitter noise floor in dBm/Hz

BW—frequency bandwidth of transmission signal in Hz Setting of P_{ref} is more complicated if said system is used for an uplink transmission. In this case, in the same frequency band there could be located an undesired signal more strong than a wanted signal. Therefore P_{ref} should be set according to the SNR not of the total incoming signal but SNR of the wanted signal. That requires a response from the Base Band (BB) processor, which is given by the multiplexer 127 in FIG. 9.

1. System for transmitting a signal via a non-linear transmission unit (200a, 200′), in particular a fibre-optical link, the system being characterized by:
a power splitter (110) for dividing the signal into a main signal and an auxiliary signal;
a power variation detector (120) for detecting power variations in said auxiliary signal and for generating a control signal representing said power variations;
a variable attenuator (130) for attenuating the power of said main signal in response to said control signal such that the power of said main signal being input to said non-linear transmission unit (200a, 200′) is kept constant; and
an amplifier (310) for amplifying the main signal after transmission via said non-linear transmission unit (200a, 200′) in response to said also transmitted control signal in order to restore the signal again.

2. The system according to claim 1, characterized in that, the power variation detector (120) comprises a comparator (126) for comparing the power of said auxiliary signal with a predetermined reference power value (P_{ref}) and for generating said control signal representing the result of said comparison.

3. The system according to claim 2, characterized in that, the control signal is embodied such that the power of the main signal is kept constant only if the power of the input signal exceeds said predetermined reference power value.

4. The system according to claim 2, characterized in that, the power variation detector (120) further comprises a power detector (124) for filtering the auxiliary signal before being input into said comparator (126).

5. The system according to claim 1, characterized by a second amplifier (200c) for amplifying said control signal after transmission before being input into the amplifier (310).

6. The system according to claim 1, characterized in that the system further comprises another transmission unit (200b) for transmitting the control signal to the amplifier (310).

7. The system according to claim 1, characterized in that the non-linear transmission unit (200′) comprises:
a laser diode (250) for converting the main signal into a first optical signal;
a light emitting device (250′) for converting the control signal into a second optical signal;
a multiplexer (210) for generating a multiplex signal by multiplexing the first and the second optical signal;
an optical fibre (260) for transmitting said multiplex signal from said multiplexer (210) to a demultiplexer (220) demultiplexer (220) for restoring said first optical signal and said second optical signal from said transmitted multiplex signal after transmission via said optical fibre (260) and for outputting the first and second optical signals to two separate photo diodes (270, 270′), respectively.

8. The system according to claim 2, characterized in that that the predetermined reference power value (P_{ref}) is output from a multiplexer (127) multiplexing a reference voltage (V_{ref}) with a response signal from a broad-band processor.

9. Method for transmitting a signal via a non-linear transmission unit (200a), in particular a fibre-optical link, the method being characterized by the steps of:
dividing the signal into a main signal and an auxiliary signal;
detecting power variations in said auxiliary signal and generating a control signal representing said power variations;
attenuating the power of said main signal in response to said control signal in that the power of said main signal being input to said non-linear transmission unit (200a) is kept constant;
transmitting the main signal via said non-linear transmission device (200a); and
restoring the signal from the transmitted main signal by amplifying the transmitted main signal in response to said also transmitted control signal.

10. The method according to claim 8, characterized in that the control signal is embodied such that the power of the main signal entering the transmission unit (200a) is kept constant only if the power of the input signal exceeds a predetermined reference power value.

11. A preparation unit (100) as a part of a system as claimed in claim 1, characterized by:
the power splitter (110), the power variation detector (120) and the variable attenuator (130).

12. A restoration unit (300) as a part of a system as claimed in claim 1, characterized by:
a variable gain amplifier (310).
